(19) United States
(12) Patent Application Publication
(10) Pub. No.: US 2012/0311943 A1
(43) Pub. Date: Dec. 13, 2012

(54) BUILDING BLOCK, SYSTEM AND METHOD

(75) Inventors: John J. Gran, Lincoln, NE (US); Daniel Thiele, Omaha, NE (US); Larry J. Ebert, Apple Valley, MN (US); Michael Furlong, Cambridge, MN (US)

(73) Assignee: STONE STRONG LLC, Lincoln, NE (US)

(21) Appl. No.: 13/158,411

(22) Filed: Jun. 11, 2011

(51) Int. Cl. E04B 2/18; B29C 39/10; E04G 21/14

(52) U.S. Cl. 52/122.1; 52/588.1; 264/40.1

(57) ABSTRACT

A block system includes a main block that has the lift and alignment devices positioned to overlie a longitudinal axis that intersects a center of gravity of the main block, and has a defined distance from the lift and alignment devices to a front surface of the main block. The block system further includes extended blocks that each has the lift and alignment devices positioned not to overlie a longitudinal axis that intersects a center of gravity of the extended block, but has the same defined distance from the lift and alignment devices to a front face of the extended block that exists on the main block. The recessed portions of the block may be larger than the lift and alignment devices, thereby allowing the blocks to be stacked in either a vertical wall or in a setback wall.

### BACKGROUND OF THE INVENTION

1. Technical Field

This invention generally relates to construction materials and techniques, and more specifically relates to a building block wall system and method that may be used to construct a wall or support.

2. Background Art

Building blocks have been used for centuries to construct homes, office buildings, churches, and many other structures. Early building blocks were hewn from stone into appropriate shapes that were assembled together, typically using mortar, to form a wall. In modern times, various types of concrete blocks have been developed, which are typically formed by pouring a cement-based concrete mixture into a form and allowing the concrete to cure. This type of concrete block is strong and makes for a sturdy wall, but installing a traditional concrete block requires a skilled mason that must manually lift each block, and set each block using mortar to secure the blocks in place. This process is very labor-intensive.

One application for concrete blocks is the construction of retaining walls. Retaining walls are required when there is a body of earth that needs to be held in place. While several different block designs have been used in the art, most of these are relatively small blocks that a construction worker must manually lift and put in place. Most require mortar and a considerable amount of labor to install. U.S. Pat. No. 6,796,098, which issued on Sep. 28, 2004, and U.S. Pat. No. 7,703,304, which issued on Jul. 11, 2006, disclose building blocks and a building block system that greatly simplifies construction of a wall using the blocks. These two patents are owned by Stone Strong LLC of Lincoln, Nebr., and are incorporated herein by reference. The blocks have a relatively large, finished surface. The blocks include one or more lift and alignment devices in the block that allow the block to be lifted using a suitable lifting apparatus, such as a crane, forklift, backhoe, etc. The blocks include one or more recessed portions in the bottom surface of the block positioned to receive the protruding lift and alignment device of a previously-laid block underneath, thereby helping to align the block with the previously-laid block. Some embodiments of the blocks include one or more voids that extend from the top surface to the bottom surface of the block, and that align with each other when the blocks are stacked into a wall, thereby allowing fill material to be placed in the voids to strengthen the wall. A wall system includes various different blocks that may be used to build a wall, including corner blocks that allow abruptly changing the direction of the wall.

### DISCLOSURE OF INVENTION

According to the preferred embodiments, a system of blocks has a finished surface that provides an attractive appearance. The blocks are relatively large in size, allowing the quick construction of a wall, such as a retaining wall, using the blocks. The blocks include one or more lift and alignment devices in the block that allow the block to be lifted using a suitable lifting apparatus, such as a crane, forklift, backhoe, etc. The blocks include one or more recessed portions in the bottom surface of the block positioned to receive the protruding lift and alignment device of a previously-laid block underneath, thereby helping to align the block with the previously-laid block. The block system includes a main block that has the lift and alignment devices positioned to overlie a longitudinal axis that intersects a center of gravity of the main block, and has a defined distance from the lift and alignment devices to a front surface of the main block. The block system further includes extended blocks that each has the lift and alignment devices positioned not to overlie a longitudinal axis that intersects a center of gravity of the extended block, but has the same defined distance from the lift and alignment devices to a front surface of the extended block that exists on the main block. The recessed portions of the blocks may be larger than the lift and alignment devices, thereby allowing the blocks to be stacked in either a vertical wall or in a setback wall. A block in the block system may include a mass extender on a back of the block to improve the load-bearing capability of the block.

A method for making a block includes the steps of determining a center of gravity for the block, determining a longitudinal axis that intersects the center of gravity for the block, and positioning one or more lift and alignment rings overlying the longitudinal axis.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a top view of a block that has lift and alignment rings overlying a longitudinal axis that intersects a center of gravity for the block;

FIG. 2 is a side view of the block of FIG. 1;

FIG. 3 is a top view of the block of FIG. 1 showing a reinforcing structure that adds strength to the block;

FIG. 4 is cross-sectional view of the block in FIG. 3 taken along the lines 4-4 that shows the connection of lift and alignment ring 170 to the reinforcing structure;

FIG. 5 is a flow diagram of a method for making a block;

FIG. 6 is a flow diagram of additional steps in the method for making a block;

FIG. 7 is a top view of a first extended block;

FIG. 8 is a top view of a second extended block;

FIG. 9 is a top view of a third extended block that includes a mass extender on its back surface to increase the load bearing capability of the block;

FIG. 10 is a side view of one alternative to the main block in FIG. 1 that includes a recess on the bottom surface that is substantially larger than the lift and alignment rings, thereby allowing the block to be stacked in either a vertical wall configuration or in a setback wall configuration;

FIG. 11 is a side view of one alternative to the extended block in FIG. 7 that includes a recess on the bottom surface that is substantially larger than the lift and alignment rings, thereby allowing the block to be stacked in either a vertical wall configuration or in a setback wall configuration;

FIG. 12 is a side view of one alternative to the extended block in FIG. 8 that includes a recess on the bottom surface that is substantially larger than the lift and alignment rings, thereby allowing the block to be stacked in either a vertical wall configuration or in a setback wall configuration;

FIG. 13 is a side diagram of a wall built with four courses of the block 100 in FIG. 1;

FIG. 14 is a side diagram of a wall built with four courses of the block 100 in FIG. 1 atop a course of extended blocks 700 in FIG. 7;

FIG. 15 is a side diagram of a wall built with four courses of the block 100 in FIG. 1, a course of extended blocks 700 in FIG. 7, and a course of extended blocks 800 in FIG. 8;

FIG. 16 is a side diagram of a vertical wall built with four courses of the block 1000 in FIG. 10, a course of extended blocks 1100 in FIG. 11, and a course of extended blocks 1200 in FIG. 12, showing how the larger recesses in the bottom surfaces of the block allow building a vertical wall; and

FIG. 17 is a side diagram of a setback wall built with the same blocks in FIG. 16.

### BEST MODE FOR CARRYING OUT THE INVENTION

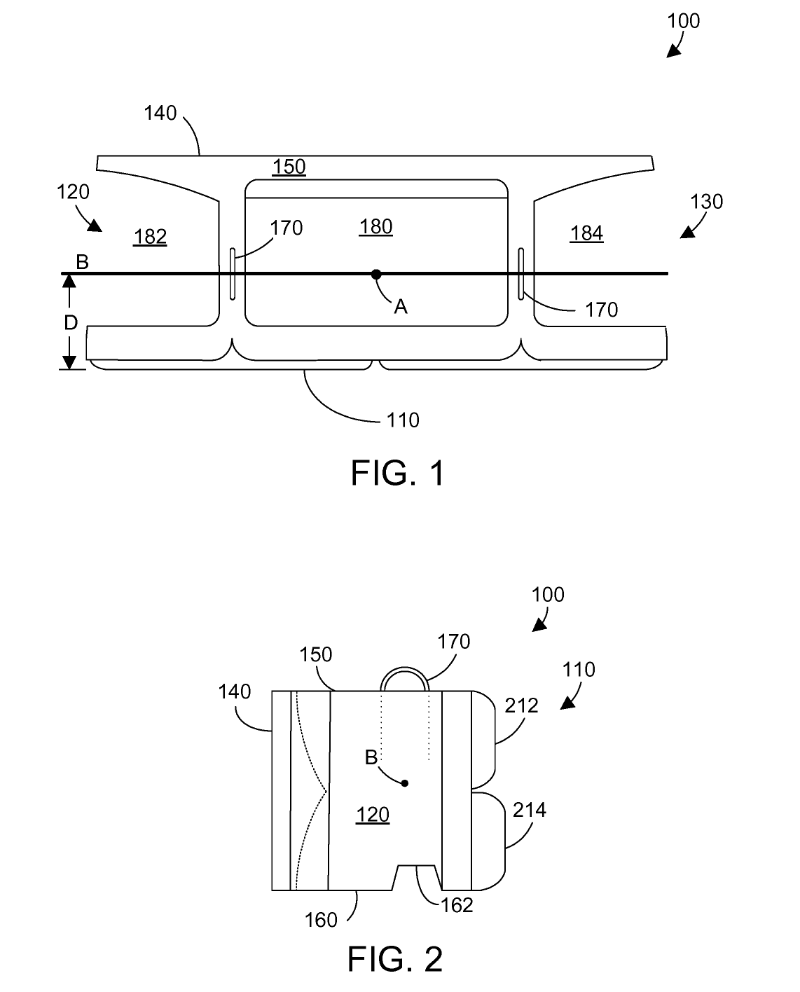

Referring now to FIGS. 1 and 2, a building block 100 includes a front surface 110, a left side surface 120, a right side surface 130, and a back surface 140, all coupled together via a top surface 150 and a bottom surface 160. Any or all of the front surface 110, the side surfaces 120 and 130, and the back surface 140 could have a finished, decorative surface that resembles stone or provides other desired appearance.

Referring to FIG. 2, for the specific configuration shown in the drawings, the front surface 110 has an uneven surface comprised of a lower finished surface 214 and an offset upper finished surface 212. The offset upper finished surface 212 gives the appearance of a separate course of stone, and enhances the look of a finished wall that is built using the block 100. The preferred embodiments, however, expressly extend to a block that has an even finished surface and that is placed in a wall to provide a straight, vertical wall surface.

Block 100 preferably includes one or more voids that extend from the top surface to the bottom surface of the block. Examples of suitable voids are shown in FIG. 1 to include a fully enclosed void 180 and two partially enclosed voids 182 and 184. When blocks 100 are laid next to each other, partially enclosed voids 182 and 184 of adjacent blocks combine to form a void similar in size to void 180. These voids are designed to align with voids of other blocks when the blocks are stacked to form a wall. The voids may be filled with an appropriate filler material, such as recycled concrete, gravel, concrete, etc. Filling the voids with an appropriate filler material increases the shear strength of a wall built using the block 100. The preferred embodiments also extend to a block 100 that is solid, and thus has no voids.

Block 100 preferably includes one or more devices that allow lifting the block 100. For example, block 100 in the figures includes two semicircular lift and alignment rings 170 (best shown in FIG. 2) that protrude from the top surface 150 of the block that allow the block to be lifted using a suitable lifting apparatus, such as a crane, forklift, backhoe, etc. Block 100 preferably includes one or more recesses or alignment channels 162 (FIG. 2) in the bottom surface 160 of the block that helps align the block 100 with a previously-laid block underneath. The alignment channel 162 is recessed into bottom surface 160, as shown in FIG. 2. In the case where the block does not have one or more voids, then alignment channel 162 would preferably run the entire width of block 100. In the most preferred implementation, the radius of the outside of the lift and alignment rings 170 is preferably 8.75 inches (22.2 cm), and the alignment channel 162 is configured to receive a lift and alignment ring with a radius of 9.5 inches (24.1 cm). The lift and alignment rings 170 may be made of any suitable material that provides sufficient strength to allow lifting the block 100 using the lift and alignment rings 170. In the preferred embodiments, lift and alignment rings 170 are made of No. 6 rebar, which may be coated with a non-corrosive coating, such as fiberglass resin. No. 6 rebar refers to a specific rebar diameter; however, the preferred embodiments include any suitable rebar diameter and any suitable coating. In addition, lift and alignment rings 170 could be made of smooth metal bar, and may be made of stainless steel or other non-corrosive material which could be used in a corrosive environment, such as on an ocean shoreline. Additionally, the preferred embodiments include any suitable radius of the lift and alignment rings 170 and any suitable geometric configuration for channel 162 to receive the lift and alignment rings 170.

The lift and alignment rings 170 are preferably placed overlying a longitudinal axis B that intersects the center of gravity A for the block 100. The center of gravity A may be determined using any suitable means, including computer modeling, calculations, or empirical tests. In the most preferred implementation, the center of the semi-circular lift rings 170 are placed directly over the axis B that intersects the center of gravity, as shown in FIG. 2. Note, however, the terms “underlying” and “underlies” as used in the disclosure and claims herein mean the lift and alignment ring 170 shown in FIG. 2 has any portion that is over the axis B when the block is positioned with its top surface 150 up, as shown by the dotted lines in FIG. 2 extending downward from the lift and alignment ring 170 in FIG. 2. By positioning the lift and alignment rings 170 to overlie the axis B that intersects the center of gravity, the block will be more level when lifted using a crane or other suitable equipment.

The semicircular shape of protruding portion of the lift and alignment rings 170 shown in FIG. 2 and the shape of the alignment channels 162 provide a mechanism for easily aligning a block on top of a previously-laid block. The block 100 of FIG. 1 is preferably heavy enough that it will typically be set in place using suitable equipment, such as a crane. The lift and alignment rings 170 provide easy loops for attaching hooks to lift the block 100. As the block is lowered into place on previously-set blocks, the shape of the alignment channel 162 has an aligning effect on the block as it is lowered onto the lift and alignment rings 170 of one or more previously-laid blocks. If the block is slightly too far to the front or back, the weight of the block will cause the block to shift as it is lowered until the lift and alignment rings 170 lie within the alignment channels 162. This is the how the lift and alignment rings 170 perform their aligning function. The lift and alignment rings thus provide a dual function. They provide lift hooks that allow lifting the block and placing it in a wall. They also provide an alignment mechanism to align the alignment channel of a subsequently-placed block with one or more lift and alignment devices of one or more blocks that have been previously placed. This dual function for lift and alignment rings 170 provides significant advantages over other building blocks.

While lift and alignment rings 170 are shown herein in a semicircle shape, and alignment channel is shown as a channel with beveled sides, the preferred embodiments expressly extend to any and all suitable geometries for lift and alignment rings 170 and alignment channel 162. For example, a semicircular lift and alignment ring 170 could be used with a rectangular or square alignment channel 162. In the alternative, both lift and alignment ring 170 and alignment channel 162 may be triangular in shape. Any suitable geometric shape for the lift and alignment ring 170 may be used with any compatible geometric shape for the alignment channel within the scope of the preferred embodiments.

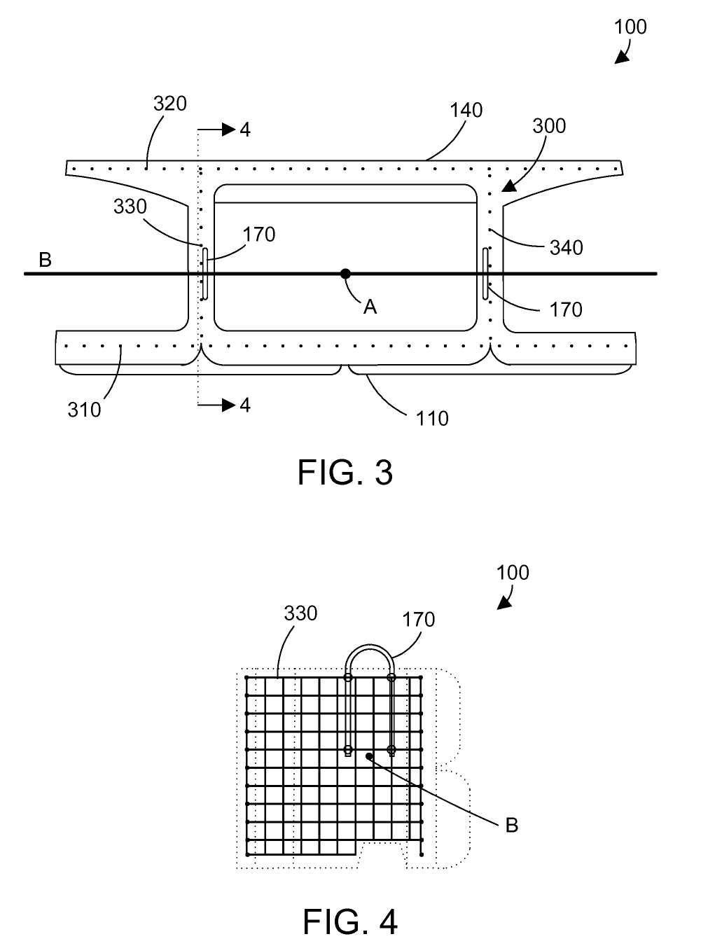

Referring now to FIG. 3, the block 100 preferably includes a reinforcing structure within the block that provides structural strength to the block. A suitable reinforcing structure 300 is shown in FIG. 3 to include a front piece 310 that runs the width of the front surface 110, a back piece 320 that runs the width of the back surface 140, a left side piece 330, and a right side piece 340. Each of these pieces preferably provides a grid-like structure that reinforces the concrete in the block. In the preferred embodiments, D4 metal wire mesh, grade 80 with a spacing of 4 inches (10.2 cm) is used. Each piece is secured to the adjacent other pieces using any suitable technique, such as tying with wire, welding, etc. In the preferred embodiments, the different pieces of the reinforcing structure 610 are attached to each other using wire ties that are tied around both adjacent pieces. Of course, the preferred embodiments extend to any suitable reinforcing structure that adds structural strength to the block, regardless of its composition or configuration. For example, rebar may be used instead of wire mesh. The reinforcing structure 610 provides structural reinforcement that allows the block 100 to be used in tall walls or in load-bearing applications, if required. In some applications, the reinforcing structure 300 may be omitted altogether.

For the preferred implementation that uses 4 inch (10.2 cm) metal wire mesh, a cross-sectional side view taken along the line 4-4 in FIG. 3 is shown in FIG. 4. Note that the block 100 is shown in phantom in FIG. 4 to more clearly show how the lift and alignment ring 170 is attached to the left side piece 330 of the reinforcing structure 300. One specific way to attach the lift and alignment ring 170 to the left side piece 330 of the reinforcing structure 300 is to wire the two together at the points indicated with small circles in FIG. 4 with wire ties. Of course, welding or any type of fastener could also be used. By attaching the lift and alignment rings 170 to the reinforcing structure 300 of the block, the lift and alignment rings 170 will not pull out of the block 100 under the weight of lifting the block 100. Note the lift and alignment rings 170 are positioned in FIG. 4 overlying the axis B that intersects the center of gravity A of the block 100. The size and properties of the reinforcing structure 300 and lift and alignment rings 170 may vary according to the engineering requirements for a wall constructed using the block 100. For applications that do not use a reinforcing structure, the lift and alignment rings 170 will be embedded in the concrete of the block without being attached to a reinforcing structure.

Block 100 is preferably comprised of a mixture of sand, gravel, cement, and water that is placed around the reinforcing structure 300 and the attached lift and alignment rings 170 to form a block. The cement is preferably Portland cement, type 1, ASTM designation C150 or similar. The resulting mix is preferably denoted L4000, which represents a mixture of sand, gravel, cement, and water in proportions that results in a finished product capable of bearing approximately 4000 pounds per square inch (280 kilograms per square centimeter). L4000 mix preferably includes entrained air, which helps the block withstand freeze and thaw cycles. Note that L4000 is a common expression in the concrete art that denotes specific proportions of the ingredients. While L4000 is the preferred block material, the preferred embodiments also extend to any other suitable block material.

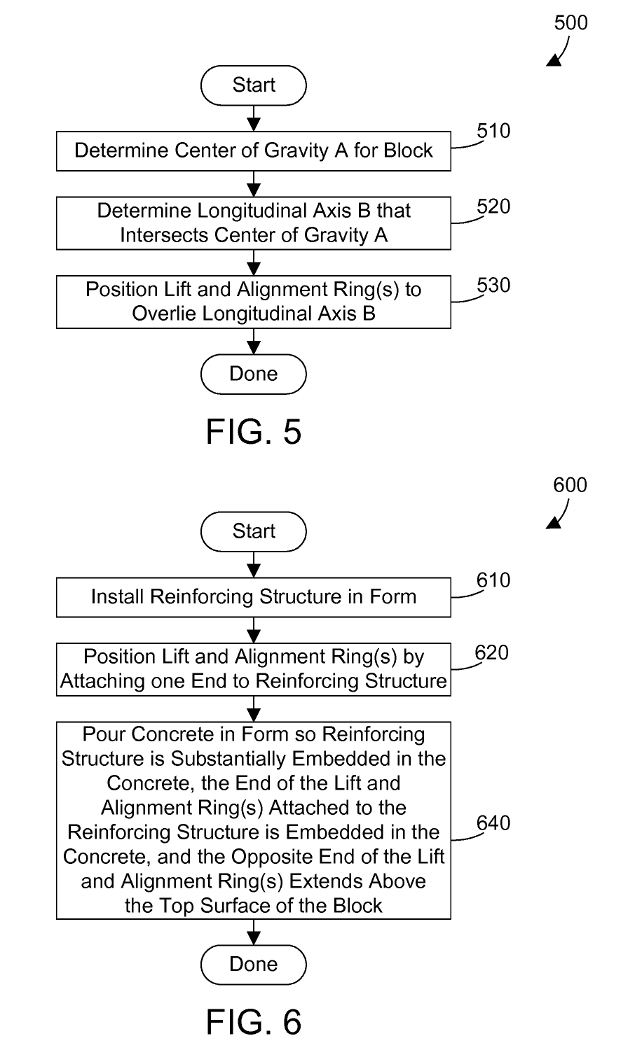

Referring now to FIG. 5, a method 500 for making a block begins by determining the center of gravity A for the block (step 510). A longitudinal axis B is then determined that intersects the center of gravity A (step 520). The lift and alignment rings are then positioned to overlie the longitudinal axis B (step 530). By positioning the lift and alignment rings to overlie the longitudinal axis B, the block will be more level when lifting the block for installation than it would otherwise be.

FIG. 6 shows a method 600 that includes additional steps that could also be performed in making the block. A reinforcing structure is installed in a form (step 610). One suitable example of such a reinforcing structure is reinforcing structure 300 shown in FIG. 3. The lift and alignment rings are then positioned to overlie the longitudinal axis B by attaching one end of the lift and alignment rings to the reinforcing structure (step 620). Concrete is then poured into the form so the reinforcing structure is substantially embedded in the concrete, the end of the lift and alignment ring(s) attached to the reinforcing structure is embedded in the concrete, and the opposite end of the life and alignment ring(s) extends above the top surface of the block (step 640). The result is lift and alignment rings that are firmly embedded in the concrete in a position that overlies the longitudinal axis B that intersects the center of gravity A, which makes installation of the block much easier.

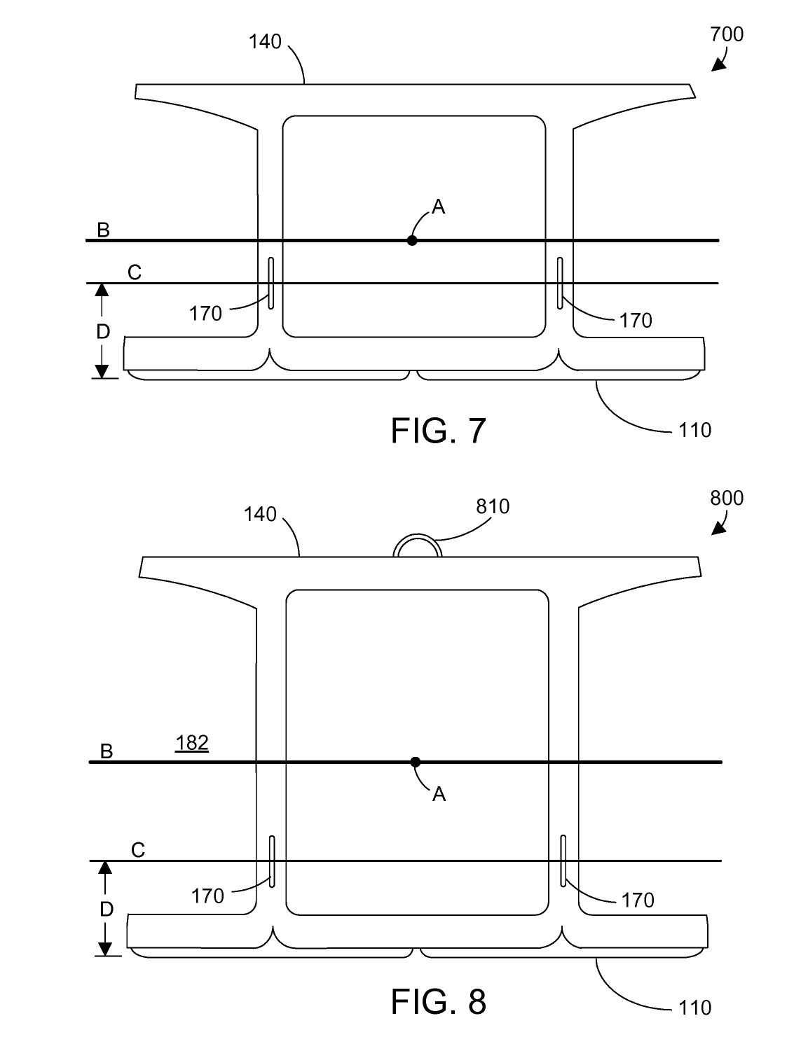

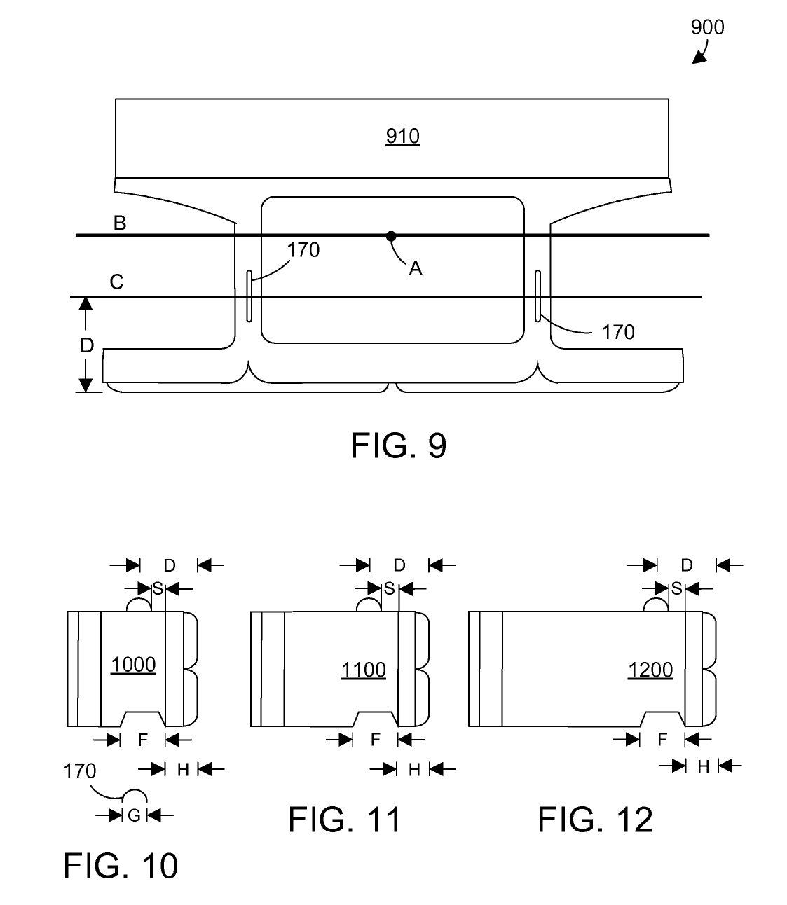

The block illustrated in FIGS. 1-4 is called a “main block” herein. In addition to the main block 100, three different types of extended blocks are also included in the block system disclosed herein. These are shown as block 700 in FIG. 7, block 800 in FIG. 8, and block 900 in FIG. 9. These blocks have a similar structure when compared to the main block, but are much wider than the main block. Extended blocks provide greater strength for a wall. For example, in the blocks currently being manufactured by Stone Strong LLC of Lincoln, Nebr., the main block is 36 inches (91.4 cm) high by 96 inches (243.8 cm) long by 44 inches (111.8 cm) wide. The first extended block 700 shown in FIG. 7 has a height and length the same as the main block 100 in FIG. 1, and has a width from front surface 110 to the back surface 140 of 62 inches (157.5 cm). The second extended block 800 shown in FIG. 8 has a height and length the same as the main block 100 in FIG. 1, and has a width from front surface 110 to the back surface 140 of 86 inches (218.4 cm). The third extended block 900 shown in FIG. 9 has a height and length the same as the main block 100 in FIG. 1, and has a width from front surface 110 to the back surface 140 of 56 inches (142.2 cm). Note that block 900 in FIG. 9 includes a relatively thick portion 910 known as a “mass extender”, which improves the load-bearing capability of the block.

Note the lift and alignment rings 170 in the extended block 700 in FIG. 7 do not overlie the axis B that intersects the center of gravity A for the block 700. Likewise, the lift and alignment rings 170 in the extended block 800 in FIG. 8 do not overlie the axis B that intersects the center of gravity A for the block 800. Similarly, the lift and alignment rings 170 in the extended block 900 in FIG. 9 do not overlie the axis B that intersects the center of gravity A for the block 900. Instead, the lift and alignment rings are positioned along a line C that is a fixed distance D from the front surface 110 for each of blocks 700, 800 and 900. Note this distance is the same as distance D shown in FIG. 1 for the main block 100 in FIG. 1. By making the distance from the front surface to the lift and alignment rings the same for all blocks 100, 700, 800 and 900, any block can be stacked atop any other block. Thus, one or more courses of the main block 100 could be placed atop one or more courses of any of the extended blocks 700, 800 or 900, or atop any suitable combination of extended blocks 700, 800 and 900, or vice versa. In addition, it is within the scope of the disclosure and claims herein to build a wall completely of one or more courses of extended blocks 700, 800 or 900 without using any main blocks 100. In one specific implementation, one or more courses of the deepest extended block 800 could be placed, followed by one or more courses of the extended block 700, followed by one or more courses of main blocks 100.

FIGS. 10, 11 and 12 show variations 1000, 1100 and 1200 of the main block 100, extended block 700, and extended block 800, respectively. Each of these blocks 1000, 1100 and 1200 includes a recess in the bottom surface that has a width F that is substantially wider than a width G of the lift and alignment ring 170 shown in FIG. 10. In the most preferred implementation, the width F of the recess is at least as wide as the sum of the width G of the lift and alignment ring plus the setback S from the front edge of the recess to the front edge of the lift and alignment ring. This allows each block to be stacked in either a vertical wall configuration or a setback wall configuration. Note also the front edge of the recess is a fixed distance H from the front surface of each block. In addition, the front surfaces of blocks 1000, 1100 and 1200 shown in FIGS. 10-12 do not have an upper half that is offset from the lower half as shown in FIG. 2, but have upper halves of the front surfaces that are aligned with the lower half of the front surfaces. The combination of the front surfaces not having an offset coupled with a larger recess allows the blocks to be stacked in either a vertical wall configuration or in a setback wall configuration.

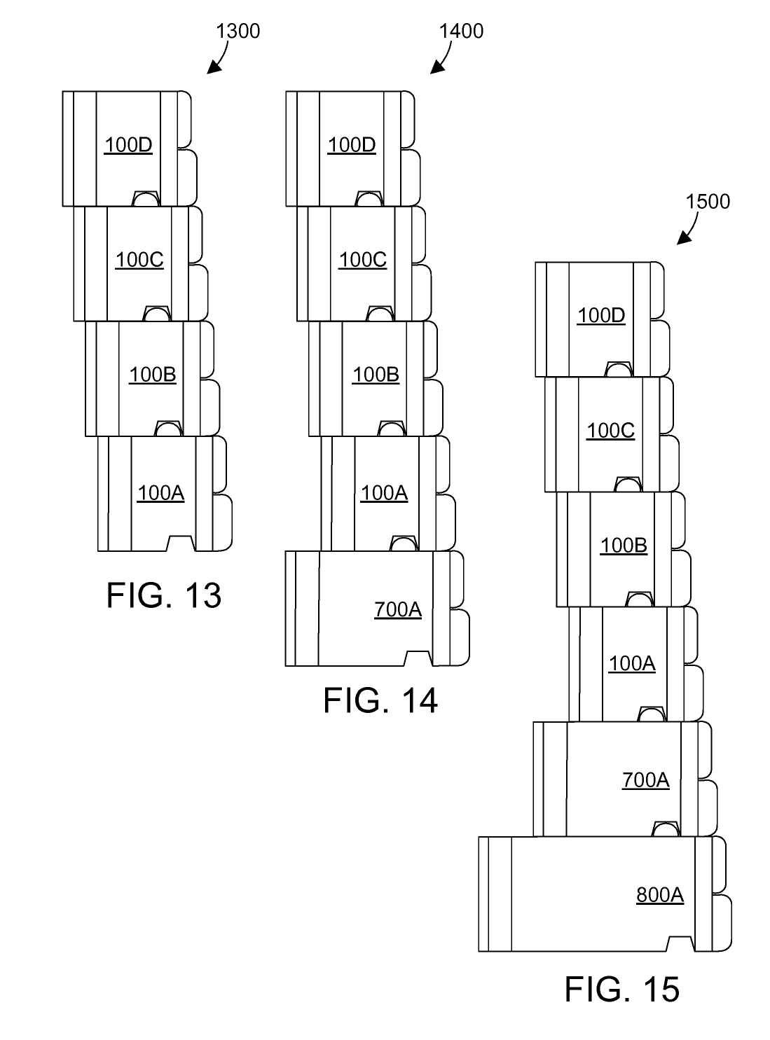

FIG. 13 illustrates a wall 1300 built with four courses of block 100 shown in FIG. 1, denoted 100A, 100B, 100C and 100D. The course 100A is placed first, followed by course 100B, followed by course 100C, followed by course 100D. FIG. 14 shows a wall 1400 built by placing a course 700A of extended blocks 700 in FIG. 7, followed by course 100A of main blocks, followed by course 100B of main blocks, followed by course 100C of main blocks, followed by course 100D of main blocks. FIG. 15 shows a wall 1500 built by placing a course 800A of extended blocks 800 in FIG. 8, followed by course 700A of extended blocks 700 in FIG. 7, followed by course 100A of main blocks, followed by course 100B of main blocks, followed by course 100C of main blocks, followed by course 100D of main blocks. Of course, other variations are possible, which are within the scope of the disclosure and claims herein.

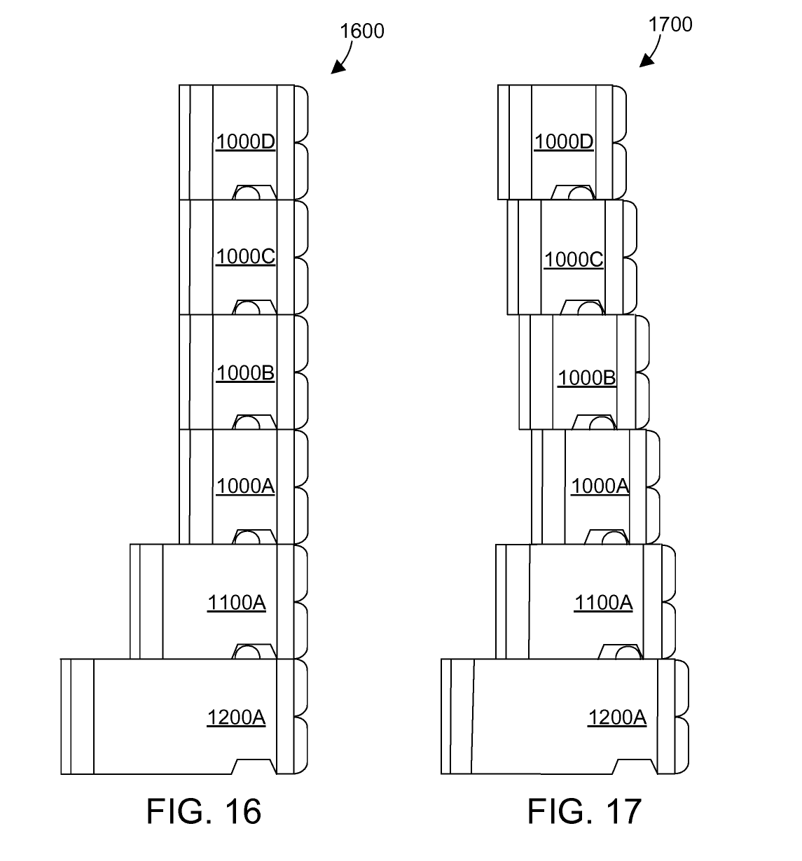

Referring to FIG. 16, a vertical wall may be built using the blocks 1000, 1100 and 1200 shown in FIGS. 10-12, respectively. The vertical wall is possible due to two variations in the design of the block, namely: 1) a front surface that has a top half that is not offset from the bottom half; and 2) a recess that is at least the width of the lift and alignment rings plus the distance from a front edge of the recess to the front surface of the block, thereby allowing greater variation in how the block is placed atop a previously-placed block. The wall 1600 in FIG. 16 is made by placing a course 1200A of extended blocks 1200 shown in FIG. 12. Next, a course 1100A of extended blocks 1100 shown in FIG. 11 is placed, followed by four courses 1000A, 1000B, 1000C and 1000D of main blocks 1000 shown in FIG. 10. For the specific configuration shown in FIGS. 10-12 and 16, a vertical wall is achieved by placing a block atop an existing block so the lift ring is in proximity to the rear wall of the recess, as shown in FIG. 16. Having the recess substantially larger than the lift and alignment ring allows the same blocks to also be built into a setback wall configuration, as shown by wall 1700 in FIG. 17. Note the blocks used in wall 1700 are identical to the blocks used in wall 1600 in FIG. 16. The difference is how these blocks are placed. For the specific configuration shown in FIGS. 10-12 and 17, a setback wall is achieved by placing a block atop an existing block so the lift ring is in proximity to the front wall of the recess, as shown in FIG. 17. By providing a recess that is larger than the lift and alignment rings, the same blocks may be stacked to form a vertical wall 1600 shown in FIG. 16 or a setback wall 1700 shown in FIG. 17.

While the specific examples in FIGS. 10-12 and 16-17 show a recess that has a front wall that defines a setback wall configuration and a rear wall that defines a vertical wall configuration, the width of the recess could be substantially larger than shown in these figures. When the recess is substantially larger than the lift and alignment ring, the lift and alignment ring may not be in proximity to the front wall or rear wall of the recess when the block is placed atop a previously-placed block. When this is the case, the precise alignment of the blocks may be achieved using other known means such as levels, tape measures and/or plumb bobs. Note, however, the recess still performs a coarse aligning function as the block is placed by requiring the lift ring be within the recess before the block can be placed in its final, desired position.

A wall system that includes the blocks disclosed herein includes main blocks such as 100 shown in FIG. 1 that have lift and alignment rings that overlie a longitudinal axis that intersects the center of gravity of the block, and one or more other blocks such as 700 in FIG. 7, 800 in FIGS. 8, and 900 in FIG. 9 that have lift and alignment rings that do not overlie a longitudinal axis that intersects the center of gravity of the block, but instead have lift rings that are the same fixed distance from the front surface of the block as in the main block. For the blocks such as 700, 800 and 900 that have lift and alignment rings that do not overlie a longitudinal axis that intersects the center of gravity of the block, these block may include one or more additional lift rings to help keep the block level when the block is placed. For example, block 800 in FIG. 8 includes a third lift ring 800 extending from the back surface. When placing block 800, hooks could be placed on the two front lift rings 170 and on the rear lift ring 810 to keep the block level when putting the block in place. Note the third lift ring could also extend from the top surface of the block near the back surface of the block, or could extend inwardly from any wall of the block. The disclosure and claims herein expressly extend to any suitable location for an additional lift and alignment ring for blocks that have one or more lift and alignment rings that do not overlie a longitudinal axis that intersects the center of gravity for the block.

While the examples of walls shown in FIGS. 14-17 show courses of main blocks on top of one or more courses of extended blocks, this is shown by way of example, and is not limiting. The blocks disclosed herein may be used in any suitable location or combination. Thus, one could build a wall made entirely of extended blocks, or could place one or more courses of extended blocks on top of main blocks. Furthermore, while “courses” of blocks are discussed herein, one skilled in the art will recognize that a course need not have identical blocks. Thus, a single course could include any suitable combination of blocks disclosed herein. This provides an extremely versatile block system, because it allows mixing and matching blocks according to specific needs.

The units herein are expressed in both English and metric units. The preferred embodiments are implemented in English units, and any variation between the stated English units and their metric equivalents is due to rounding errors, with the English units being the more correct measurement of the two.

The building blocks, system and methods disclosed herein allow quick construction of a wall, such as a retaining wall, using the blocks. The blocks include one or more lift and alignment devices in the block that allow the block to be lifted using a suitable lifting apparatus, such as a crane, forklift, backhoe, etc. The blocks include one or more recessed portions in the bottom surface of the block positioned to receive the protruding lift and alignment device of a previously-laid block underneath, thereby helping to align the block with the previously-laid block. The block system includes a main block that has the lift and alignment devices positioned to overlie a longitudinal axis that intersects a center of gravity of the main block, and has a defined distance from the lift and alignment devices to a front surface of the main block. The block system further includes extended blocks that each has the lift and alignment devices positioned not to overlie a longitudinal axis that intersects a center of gravity of the extended block, but has the same defined distance from the lift and alignment devices to a front surface of the extended block that exists on the main block. The recessed portions of the blocks may be larger than the lift and alignment devices, thereby allowing the blocks to be stacked in either a vertical wall or in a setback wall. A block in the block system may include a mass extender on a back of the block to improve the load-bearing capability of the block.

A method for making a block includes the steps of determining a center of gravity for the block, determining a longitudinal axis that intersects the center of gravity for the block, and positioning one or more lift and alignment rings overlying the longitudinal axis.

While the invention has been particularly shown and described with reference to preferred embodiments thereof, it will be understood by those skilled in the art that various changes in form and details may be made therein without departing from the spirit and scope of the invention. For example, a block may be made in a variety of different sizes. In addition, the size, number and geometries of the block surfaces and voids in the block may vary from that disclosed herein. Furthermore, while the block herein is described as being used for retaining walls, it is equally within the scope of the preferred embodiments to use the building block for other purposes, such as building construction.

1. A method for making a block, the method comprising the steps of:
(A) determining a center of gravity for the block;
(B) determining a longitudinal axis running the length of the block that intersects the center of gravity for the block; and
(C) positioning an alignment device overlying the longitudinal axis that intersects the center of gravity for the block, the alignment device comprising a device for lifting the block when the block is being placed.

2. The method of claim 1 further comprising the steps of:
installing a reinforcing structure in a form;
performing step (C) by attaching a first end of the alignment device to the reinforcing structure in the form in a position overlying the longitudinal axis; and
pouring concrete in the form so the reinforcing structure is substantially embedded in the concrete, the first end of the alignment device is embedded in the concrete, and a second end of the alignment device extends above a top surface of the block.

3. The method of claim 2 wherein the concrete comprises a mixture of sand, gravel, water, and cement in a mix rated at a minimum of 4000 pounds per square inch (280 kilograms per square centimeter).

4. The method of claim 1 further comprising the step of forming in a bottom surface of the block at least one recess positioned to receive at least one alignment device of a previously-placed block to align the block with respect to the previously-placed block.

5. The method of claim 1 wherein the recess has a size sufficiently greater than the at least one lift and alignment device of the previously-placed block to allow the block to be stacked in either a vertical wall configuration where a front surface of the block aligns with a front surface of the previously-placed block, or in a setback wall configuration where the front surface of the block is set back from the front surface of the previously-placed block.

6. The method of claim 1 wherein each alignment device comprises a substantially semicircular portion of material protruding from the top surface.

7. The method of claim 6 wherein the semicircular portion of material comprises metal bar.

8. The method of claim 1 wherein step (C) comprises the step of positioning the alignment device in a position where a middle of the alignment device is directly over the longitudinal axis that intersects the center of gravity for the block.

9. A block comprising:
a back surface;
a first side surface and a second side surface coupled to the back surface;
a top surface coupled to the back surface and to the first side surface and the second side surface, wherein the top surface includes at least one lift and alignment device for lifting the block when the block is being placed, each lift and alignment device aligning a subsequently-placed block with respect to the block, each lift and alignment device overlying a longitudinal axis that intersects a center of gravity for the block; and
a bottom surface coupled to the back surface and to the first and second side surfaces, the bottom surface including at least one recess positioned to receive at least one lift and alignment device of a previously-placed block, the at least one recess having a size sufficiently greater than the at least one lift and alignment device of the previously-placed block to allow the block to be stacked in either a vertical wall configuration where a front surface of the block aligns with a front surface of the previously-placed block, or in a setback wall configuration where the front surface of the block is set back from the front surface of the previously-placed block.

10. The block of claim 9 wherein the alignment device is in a position where a middle of the alignment device is directly over the longitudinal axis that intersects the center of gravity for the block.

11. The block of claim 9 wherein the at least one recess includes a front wall and a rear wall, wherein the at least one lift and alignment device of the previously-placed block is in proximity to the rear wall when the block is stacked in the vertical wall configuration.

12. The block of claim 9 wherein the at least one recess includes a front wall and a rear wall, wherein the at least one lift and alignment device of the previously-placed block is in proximity to the front wall when the block is stacked in the setback wall configuration.

13. The block of claim 9 wherein the size of the at least one recess is at least the corresponding size of the at least one lift and alignment device plus a distance from the front edge of the recess to the front edge of the lift and alignment ring.

14. A block comprising:
a back surface;
a first side surface and a second side surface coupled to the back surface;
a top surface coupled to the back surface and to the first side surface and the second side surface, wherein the top surface includes at least one lift and alignment device for lifting the block when the block is being placed, each lift and alignment device aligning a subsequently-placed block with respect to the block, each lift and alignment device not overlying a longitudinal axis that intersects a center of gravity for the block; and
a bottom surface coupled to the back surface and to the first and second side surfaces, the bottom surface including at least one recess positioned to receive at least one lift and alignment device of a previously-placed block.

15. The block of claim 14 wherein the at least one recess in the bottom surface has a size sufficiently greater than the at least one lift and alignment device of the previously-placed block to allow the block to be stacked in either a vertical wall configuration where a front face of the block aligns with a front face of the previously-placed block, or in a setback wall configuration where the front face of the block is set back from the front face of the previously-placed block.

16. The block of claim 14 further comprising a mass extender on the back surface of the block that increases load-bearing capacity of the block.

17. The block of claim 14 further including a lift device near a back surface of the block.

18. A wall system for building a wall comprising:
(A) a main block comprising:
a first back surface;
first and second side surfaces coupled to the back surface;
a first top surface coupled to the back surface and to the first and second side surfaces, wherein the first top surface includes a first lift and alignment device for lifting the main block when the main block is being placed, the first lift and alignment device aligning a subsequently-placed block with respect to the main block, the first lift and alignment device overlying a first longitudinal axis that intersects a first center of gravity for the main block, resulting in the first lift and alignment device being a predetermined distance from a first front face of the main block; and
a first bottom surface coupled to the first back surface and to the first and second side surfaces, the bottom surface including at least one recess positioned to receive the lift and alignment device of a previously-placed block;
(B) a extended block comprising;
a second back surface;
third and fourth side surfaces coupled to the second back surface;
a second top surface coupled to the second back surface and to the third and fourth side surfaces, wherein the second top surface includes a second lift and alignment device for lifting the extended block when the extended block is being placed, the second lift and alignment device aligning a subsequently-placed block with respect to the extended block, the second lift and alignment device being the same predetermined distance from a second front surface of the extended block as the distance from the first lift and alignment device to the first front surface of the main block, wherein the second lift and alignment device does not overlie a second longitudinal axis that intersects a second center gravity for the extended block.

19. The wall system of claim 18 further comprising the main block having the first back surface and a first front surface that are both finished surfaces of the block that resemble stone.

20. The wall system of claim 18 wherein the main block and the extended block both include at least one void extending from the first top surface to the first bottom surface.
